(19) United States
(12) Patent Application Publication
(10) Pub. No.: US 2003/0189318 A1
(43) Pub. Date: Oct. 9, 2003

(54) Cart for trick-or-treating or the like

(76) Inventors: Linda J. Clark, O'Fallon, IL (US); Jim Clark, Troy, IL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/116,950

(22) Filed: Apr. 5, 2002

(51) Int. Cl. B62B 1/00

(52) U.S. Cl. 280/652; 280/47.26

(57) ABSTRACT

A cart for trick-or-treating or the like is described, in which a hollow container for collecting and transporting treats or other items is coupled to an L-shaped wheeled cart framework, and a lid portion on the container that is levered opened and closed by means of a plunger slidably coupled to the cart framework. For trick-or-treating, the lid portion includes a light source and the hollow container is configured as a face of a character such as a jack-o-lantern, ghost, witch, or the like.

### BACKGROUND OF THE INVENTION

The invention relates generally to carts and, more specifically, to toy carts for use by children to collect treat items during trick-or-treating or the like.

Trick-or-treating is a very popular activity for children, including very young children, at Halloween. Traditionally, trick-or-treating is done at dusk or in the evening, when visibility is low, so that trick-or-treaters and their chaperones are at increased risk of injury from passing vehicles and from missteps while walking on streets, lawns, sidewalks, driveways and the like in the dark. To increase their visibility and improve their vision in the dark, trick-or-treaters and accompanying adults frequently carry flashlights or flashers or dress in reflective clothing. In addition, lighted Halloween carriers for collecting the treat items are known. Typically, such carriers include a hand-carried flexible bag or sack that is decoratively illuminated with one or more lights on the exterior, or a hand-carried decorative bucket-like container provided with an internal or external light source. However, being hand-carried, such carriers quickly become heavily weighted down with collected treats, and can interfere with walking, especially for small children. The addition of a light source such as a battery-powered low-power lamp exacerbates the weight and bulk problem. On the other hand, hand-carried bucket-like containers are often of very limited size, thus limiting the number of items that can be collected. The addition of an internal light source only exacerbates the space limitation.

Wheeled toy carts are known, including toy doll strollers and carriages, toy shopping carts, and wagons. Such toy carts and wagons are not suitable for collecting and holding small treat items at night because they lack a suitable container for receiving and retaining small treat items, lack a light source for increased visibility, are too bulky or heavy, or are unstable or otherwise unsuited for traversing uneven or unpaved terrain.

In the field of travel luggage, wheeled carry-on suitcases are known. However, such suitcases are clearly ill-suited for trick-or-treating for a variety of reasons. The typical cost of even child-sized carry-on luggage renders them an impractical choice for an annual seasonal event such as trick-or-treating. The suitcase compartment is not designed for collecting items at brief, repeated door-to-door stops, which requires brief and repeated access to the interior of a collecting container. The suitcase compartment is not designed to protect lightly wrapped food items from extended exposure to the outdoor environment, which can include soaking wet weather. The exterior, typically fashioned from synthetic fabric or vinyl, can be easily ripped or otherwise damaged by low branches, fences, or other features of a neighborhood landscape. Further, since suitcases are intended for travel at any time, they do not include decorative seasonal markings and details typically desired by children at times such as Halloween.

Thus, a need remains for a low-cost, practical and decorative means for children to easily collect and transport treat items during trick-or-treating or the like. A need also remains for a container for trick-or-treating or the like that avoids the difficulties of hand-carried bags or buckets that become weighty and bulky as items are collected.

### BRIEF SUMMARY OF THE INVENTION

A cart for collecting and transporting multiple items, such as candy or treat items while trick-or-treating or the like, is provided. The cart includes a hollow container with at least a side wall, a bottom wall, and a top opening for receiving and removing the items. The hollow container is coupled to an L-shaped framework including a base portion with at least one wheel, and an upright portion including at least one upright member to which is coupled a plunger, the plunger having a first end and a second end, the plunger being movable between a first position and a second position. A lid portion is pivotally coupled to the hollow container for movement between a closed position covering the container top opening and an open position providing access to said top opening. A levering means such as a lever bar extends from the lid portion and is coupled to the plunger second end so that the plunger while in the first position maintains the lid portion in the closed position and the plunger while in the second position maintains the lid portion in the open position, to provide access to the interior of the hollow container through the top opening.

The present invention is also directed to a child's cart for collecting and transporting toy and treat items, the cart including a hollow container including a side wall, a bottom wall, and a top opening for receiving and removing the items, and at least one side wall comprising a face of a character. The hollow container is coupled to an L-shaped framework having a base portion supporting the hollow container, and an upright portion with at least one upright member and a plunger coupled thereto, the plunger being movable between a first position and a second position, the base portion having at least one wheel for rolling the framework. A lid portion is pivotally coupled to the hollow container for movement between a closed position covering the hollow container top opening and an open position providing access to the top opening, the lid portion coupled by a lever to the plunger so that the plunger in the first position maintains the lid portion in the closed position and the plunger while in the second position maintains the lid portion in the open position.

### BRIEF DESCRIPTION OF THE DRAWINGS

FIG. 1 is front elevational view of a cart for trick-or-treating or the like;

FIG. 2 is a side perspective view of the cart;

FIG. 3 is a rear elevational view of the cart;

FIG. 4 is a bottom plan view of a lid portion of a hollow container of the cart; and

FIG. 5 is a top plan view the lid portion and the hollow container of the cart.

### DETAILED DESCRIPTION OF THE INVENTION

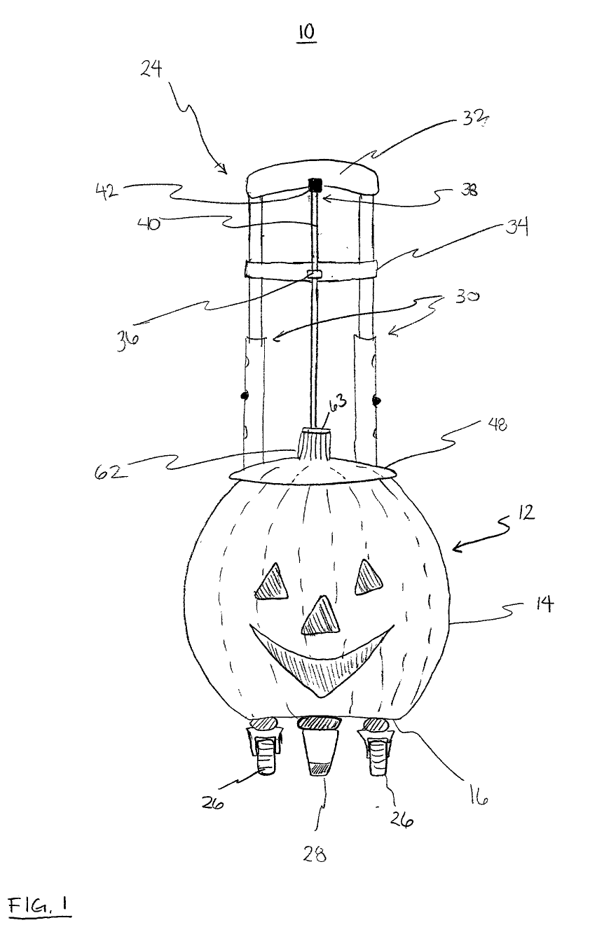

FIG. 1 is a front elevational view of an exemplary embodiment of a cart 10 for collecting multiple items such as candy or treat items while trick-or-treating or the like. Cart 10 includes a hollow container 12 having a generally cylindrical or spherical side wall 14 extending from a bottom wall 16. Container 12 tapers inwardly to form a top opening 18 (not shown in FIG. 1) that is sized sufficiently for receiving the items, such as the small individually packaged candy items typically offered to trick-or-treaters. The interior of hollow container 12 is adapted to form a receptacle for receiving the items. Container 12 is fabricated from any suitable material, which in an exemplary embodiment is molded plastic, that is molded or otherwise formed in the shape of a character representing a holiday theme having a characteristic face or facial markings. For Halloween, for example, the character is a pumpkin with a jack-o-lantern face as shown in FIG. 1, or alternatively is a witch, a ghost, a devil, a skull, a black cat, or the like. Side wall 14 is provided with markings, contours and details, including characteristic facial features, to resemble the character.

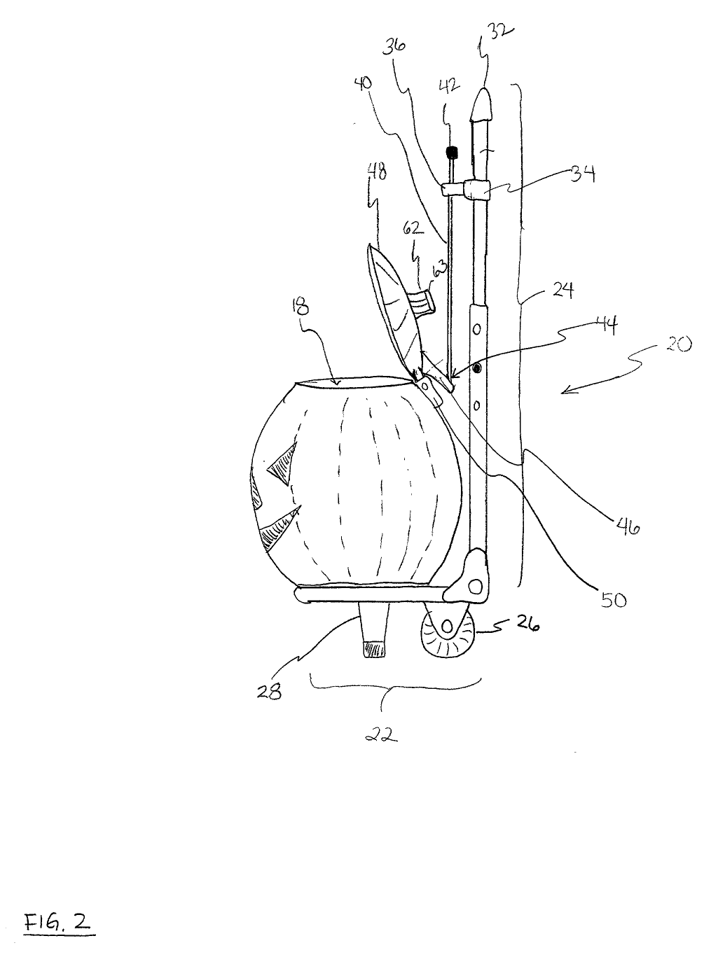

FIG. 2 is a side perspective view of cart 10. Container 12 is coupled to a wheeled, generally L-shaped framework 20 including a wheeled base portion 22 and an upright portion 24. L-shaped framework 20 is, for example, a framework of the type typically used in wheeled carry-on luggage, of a tubular construction made of metal, plastic, rubber or some combination thereof. Framework base portion 22 forms a platform-like extension that extends at an approximate right angle from upright portion 24. Base portion 22 in one embodiment includes a solid, shelf-like member extending from upright portion 24, but in an exemplary embodiment as shown in FIGS. 1-3, base portion 22 includes simply a plurality of elongate, tubular members that extend from upright portion 24 to provide support for hollow container 12. At least one wheel, or multiple wheels 26 are coupled to base portion 22. In one embodiment a stopper or stabilizer 28 is also coupled to base portion 22 to stabilize L-shaped framework in an upright position. Wheels 26 can be castored, and may be plastic, metal, or rubber, and can include motion-sensitive light elements that light up as the wheels rotate. Container 12 is secured at bottom wall 16 to base portion 22, for example by staples, rivets, screws, adhesive, or any other suitable securing means.

Upright portion 24 includes a pair of upright members 30, a handle 32 extending there between and coupled thereto, and a brace member 34 also extending between the pair of upright members 30 and coupled thereto. Brace member 34 is fabricated, for example, from a plastic or rubberized material. Upright members 30 slidably engage openings through brace member 34 which is held in position relative to upright members 30 by frictional force, yet brace member 34 is configured so that brace member can be repositioned relative upright members 30. Container 12 is preferably oriented on base portion 22 so that the face on container 12 is not obscured by upright members 30, for example “facing” in a direction away from upright members 30. Extending from brace member 34 is a rigid loop or eye 36 having an opening through which is threaded a first, upper end 38 of a plunger rod 40. Plunger rod 40 has a generally vertical extent, and plunger rod 40 and loop 36 are suitably proportioned so that rod 40 slidably moves freely back and forth through loop 36. A knob 42 fabricated from a material such as plastic or rubber is secured to the upper end of 38 of rod 40. A second, lower end 44 of plunger rod 40 is coupled, as described in greater detail infra, to a lever means 46, such as an elongate member or bar that extends from a lid portion 48 of container 12. The lever means is, for example, molded integrally from plastic with lid portion 48, or is alternatively a separate metal or plastic elongate member or bar secured to lid portion using suitable securing means such as an adhesive or hardware such as pins, staples, screws, brads or the like.

Lid portion 48 is pivotally coupled, for example by a hinge mechanism 50 to container 12, adjacent top opening 18. Lever means 46 extends generally outwardly from an upper surface of lid portion 48 and adjacent hinge mechanism 50 so that when downward force is applied to a free end 52 of lever member 46, lid portion 48 by pivotal action opens from a closed position as shown in FIG. 1 to an open position as shown in FIG. 2. Second end 44 of plunger rod 40 is secured to free end 52 of lever member 46 so that a downward force is applied to lever member free end 52 when plunger rod 40 is manually impelled downward. Thus, downward force manually applied to upper end 38 of rod 40 causes lid portion 48 to move from the closed position to the open position.

Lid portion 46 is sufficiently proportioned to cover top opening 18 when in the closed position as shown in FIG. 1. In the open position as shown in FIG. 2, lid portion 48 provides access to the interior of container 12 for receiving and removing items. Lid portion 48 is, like container 12, fabricated of a molded plastic or other suitable material and is provided with markings, details and contours to represent features or details of the character, such as, for example, the top of a pumpkin with a stem, a witch's hat, or the like, thus enhancing the characteristic appearance of container 12.

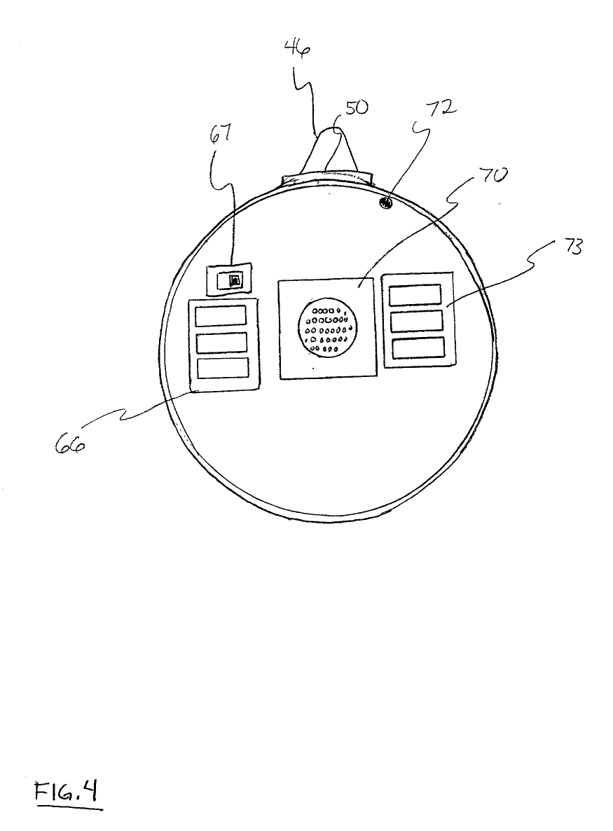

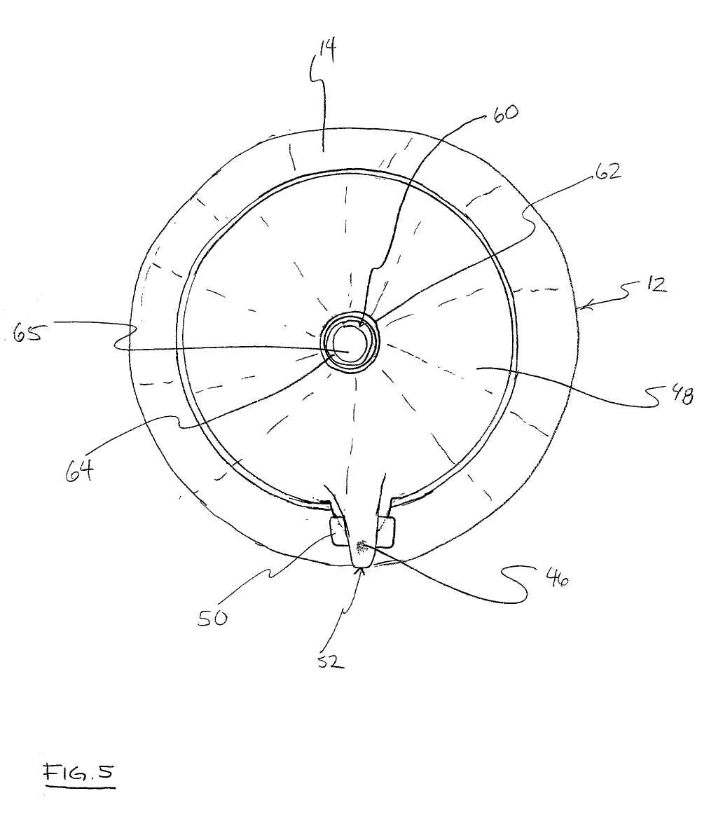

FIG. 4 is a bottom plan view of lid portion 48, and FIG. 5 is a top plan view of lid portion 48. In an exemplary embodiment especially suitable for collecting items in darkness such as for trick-or-treating by night, a light source 60 is detachably mounted to lid portion 48. In an exemplary embodiment lid portion 48 includes a hollow, translucent light source retaining member 62, which is for example a generally cylindrical projection extending from the top of lid portion 48, having a top access opening capped with a lid 63 as shown in FIGS. 1-3. For coupling light source 60 to lid portion 48, light source retaining member 62 is formed with, for example, detentes, grooves or a threaded surface (not shown) for cooperatively engaging, respectively, mating indentations, grooves or threads (also not shown) on a housing 64 of light source 60. Alternatively, light source retaining member 62 is formed to provide a press-fit flange that cooperates with a mating press-fit flange of housing 64. Light source retaining member 62 can be formed integrally as a character detail on lid portion 48. More specifically, in one embodiment as shown in FIGS. 1-3 and 5, light source retaining member 62 is a hollow generally cylindrical projection bearing markings and contours representing a pumpkin stem. It is contemplated that the shape, markings and contours of light source retaining member 62 be suitably adapted as desired to represent any of numerous other characteristic or fanciful features, such as a devil's horn, cat's ear, or the like.

In an exemplary embodiment, light source 60 is an electric lamp assembly such as that typically used in low-power lamps such as flashlights, including a light bulb 65, batteries in a battery compartment 66, a reflector (not shown) and a switch element 67, as well as housing 64. In an exemplary embodiment as shown in FIG. 4, battery compartment 66 and light switch element 67 are mounted at on the underside of lid portion 48 at some distance from bulb 65 and the reflector of the electric lamp assembly. Other suitable locations for mounting light switch element 67 are on handle 32, or adjacent handle 32 on an upright member 30. Light source 60 is alternatively a chemically luminescent light source, such as an activated chemical light stick with a plastic housing that is removably seated in light source retaining member 62.

Cart 10 further includes a battery-powered electronic speaker assembly 70 such as that typically found in electronic novelty toys. Speaker assembly is mounted, for example, on the underside of lid portion 48. In an exemplary embodiment, speaker assembly 70 includes a depressible switch 72 such as a depressible button that is biased by a biasing means such as a spring towards a first, extended position, and a battery compartment 73. Switch 72 is configured to electronically activate speaker assembly 70 to emit a pre-recorded sound or sound when switch 72 is in the first, extended position. Yet switch 72 is mounted on lid portion 48 sufficiently near hinge mechanism 50 so that when lid portion 48 is in the closed position, switch 72 is depressed by side wall 14 of container 12 to a second, depressed position in which switch 72 deactivates speaker assembly 70 so that no sound is emitted. Thus, in operation, when lid portion 48 is raised to the open position to collect trick-or-treat items, switch 72, being biased towards the first, extended position, activates speaker assembly 70 so the prerecorded sound or sounds are emitted. When lid portion 48 is returned the closed position, switch 72 is depressed, and no sound or sounds are emitted. Speaker assembly 70 is configured to emit a pre-recorded sound or sounds that might be made by, or associated with, the character of container 12, such as a scream, a cackle, a frightening moan, a meow, or the like. The pre-recorded sound can also include a voice saying “Trick-or Treat!” “Happy Halloween!”, “Boo!” or the like. The sounds selected for the pre-recorded sounds are limited only by the typically brief (usually about no more than about 10 seconds) period of the recording medium in such speaker assemblies, and the sounds can be adapted as desired for any seasonal event or holiday.

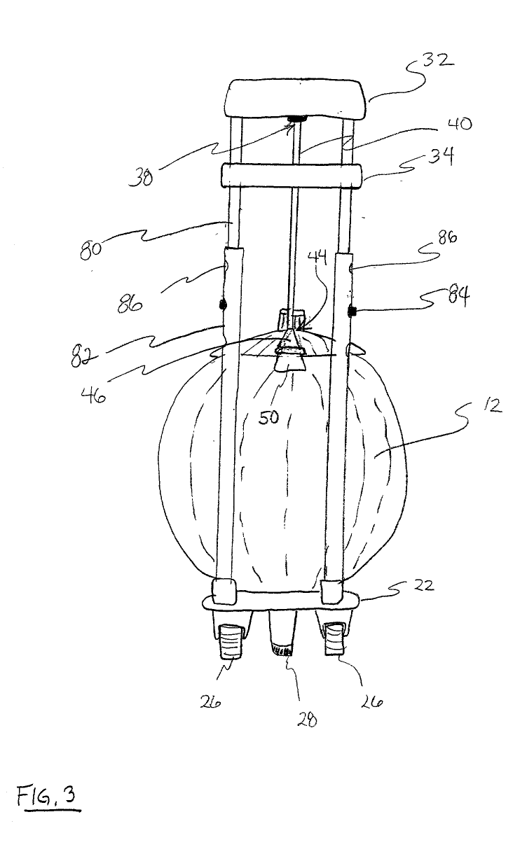

In an exemplary embodiment, upright members 30 each include two telescoping tubular elements, such as an upper, inner element 80 and a lower, outer element 82 that are slidably engaged with one another so that so that the height of upright portion 24 is adjustable. A locking element 84, or multiple such locking elements, such as an outwardly biased depressible button or pin is mounted on inner tubular element 80 and configured to insert one of multiple openings 86 oriented along the length of outer tubular element 82, thus to lock tubular elements 80 and 82 in place relative to one another. In an exemplary embodiment as shown in FIG. 3, each inner element 80 of the pair of upright members 30 has a locking element 84 at the same position along the length of the respective inner element 80, and each outer element 82 has three openings along its length. Alternatively, tubular elements 80 and 82 can be held in a position relative to one another by a rubber gasket or the like that provides frictional resistance to preclude slipping of the two telescoping tubular elements with respect to one another.

In use, a child using cart 10 to trick-or-treat at night, simply grasps cart 10 by handle 28 and pulls the cart along behind her, or pushes it in front of her. To improve her visibility and vision, she activates light source 60 by manually switching the light source “on” using manual switch 62. To collect treats being distributed by an individual, the child brings cart 10 around in front of her, positioning cart 10 with upright members 30 closest to her and the face on container 12 generally facing away from her. The child opens lid portion 48 by pushing downwardly on plunger rod 40 so that lid portion 48 is levered open from the closed position to the open position as shown in FIG. 2, thus providing access to the interior of container 12. To maintain lid portion 48 in the open position, the child need merely maintain a light downward force on plunger rod 40. Upon opening lid portion 48, speaker assembly switch 72, being biased towards the extended position, is physically permitted to extend to the extended position, and thus activates speaker assembly 70 to emit the prerecorded sound or sounds. After collecting the treats, the child releases plunger rod 40 so that the weight of lid portion 48 causes lid portion 48 to return to the closed position as shown in FIG. 1, and switch 72 is depressed by side wall 14 or a rim thereof to the depressed position, thus deactivating speaker assembly 70.

It will be appreciated by those skilled in the art that various changes and modifications can be made in the illustrated apparatus without departing from the scope of the invention. Therefore, the foregoing description and accompanying figures are intended to be illustrative only and should not be construed in a limiting sense.

What is claimed is:

1. A cart for collecting multiple items comprising:
a hollow container comprising at least a side wall, a bottom wall, and a top opening for receiving and removing the items;
an L-shaped framework having a base portion supporting said hollow container, and an upright portion comprising at least one upright member and a plunger coupled thereto, said plunger having a first end and a second end, said plunger movable between a first position and a second position, at least one wheel coupled to said base portion for rolling the framework; and
a lid portion pivotally coupled to said hollow container for movement between a closed position covering said top opening and an open position providing access to said top opening, said lid portion with a levering means extending therefrom, said levering means coupled to said plunger second end so that said plunger while in the first position maintains said lid portion in the closed position and said plunger while in the second position maintains said lid portion in the open position.

2. A cart in accordance with claim 1 further comprising a light source coupled to said lid portion.

3. A cart in accordance with claim 2 wherein said lid portion comprises a light source retaining member, said light source detachably mounted to said light source retaining member.

4. A cart in accordance with claim 3 wherein said light source comprises an electric lamp assembly comprising a housing detachably mounted to said light source retaining member.

5. A cart in accordance with claim 3 wherein said light source comprises a chemically luminescent light assembly comprising a housing detachably mounted to said light source retaining member.

6. A cart in accordance with claim 1 further comprising an electronic speaker assembly coupled to said lid portion and configured to emit a sound when said lid portion is in the open position.

7. A cart in accordance with claim 6 wherein said electronic speaker assembly comprises a switch element having a first position in which said switch activates said speaker assembly to emit a sound, and a second position in which said switch deactivates said speaker assembly, said switch biased towards the first position and mounted on said lid portion in a position so that when said lid portion is in the open position, said switch is in the first position and when said lid portion is in the closed position, said switch is depressed to the second position.

8. A cart in accordance with claim 1 wherein said hollow container comprises a face of a character.

9. A cart in accordance with claim 1 wherein said at least one upright member has a length and comprises means for manually adjusting said length.

10. A child's cart for collecting and transporting toy and treat items comprising:
a hollow container comprising a side wall, a bottom wall, and a top opening for receiving and removing the items, at least one side wall comprising a face of a character;
an L-shaped framework having a base portion supporting said hollow container, and an upright portion comprising at least one upright member and a plunger coupled thereto, said plunger movable between a first position and a second position, said base portion having at least one wheel for rolling the framework; and
a lid portion pivotally coupled to said hollow container for movement between a closed position covering said top opening and an open position providing access to said top opening, said lid portion coupled by a lever to said plunger so that said plunger in the first position maintains said lid portion in the closed position and said plunger while in the second position maintains said lid portion in the open position.

11. A cart in accordance with claim 10 further comprising a light source coupled to said lid portion.

12. A cart in accordance with claim 11 wherein said lid portion comprises a light source retaining member, said light source detachably mounted to said light source retaining member.

13. A cart in accordance with claim 12 wherein said light source comprises an electric lamp assembly comprising a housing detachably mounted to said light source retaining member.

14. A cart in accordance with claim 12 wherein said light source comprises a chemically luminescent light assembly comprising a housing detachably mounted to said light source retaining member.

15. A cart in accordance with claim 10 further comprising an electronic speaker assembly coupled to said lid portion and configured to emit a sound when said lid portion is in the open position.

16. A cart in accordance with claim 15 wherein said electronic speaker assembly comprises a switch element having a first position in which said switch activates said speaker assembly to emit a sound, and a second position in which said switch deactivates said speaker assembly, said switch biased towards the first position and mounted on said lid portion in a position so that when said lid portion is in the open position, said switch is in the first position and when said lid portion is in the closed position, said switch is depressed to the second position.

17. A cart in accordance with claim 10 wherein said hollow container comprises a face of a character.

18. A cart in accordance with claim 10 wherein said at least one upright member has a length and comprises means for manually adjusting said length.
